(19) United States
(12) Patent Application Publication
(10) Pub. No.: US 2014/0058537 A1
(43) Pub. Date: Feb. 27, 2014

(54) Methods, Systems, and Products for Controlling Devices

(71) Applicant: Larry T. Jost, St. Louis, MO (US)

(72) Inventor: Larry T. Jost, St. Louis, MO (US)

(73) Assignee: AT&T INTELLECTUAL PROPERTY I, L.P., Atlanta, GA (US)

(21) Appl. No.: 13/594,821

(22) Filed: Aug. 26, 2012

(51) Int. Cl. G05B 11/01; G06F 17/30

(52) U.S. Cl. 700/16; 707/769; 707/E17.014

(57) ABSTRACT

Methods, systems, and products describe cloud-based automation of home and industrial programmable controllers. A server executes a packet generation application for controlling an output device. The server then sends a package of commands to a programmable controller. Each command is executed according to date and time to control the output device. Because the packet generation application is cloud-based, different programs may be offered by competing vendors. The programmable controller may thus be agnostic to the packet generation application. The marketplace may thus develop a variety of server-based packet generation applications, each with different features, for controlling the output device.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Programmable controllers are widely available for control of devices. A programmable controller, for example, may turn on lights, set a thermostat, and lock doors. Programmable controllers, however, may also control more sophisticated industrial equipment, such as motors, pumps, and machinery.

### BRIEF DESCRIPTION OF THE SEVERAL VIEWS OF THE DRAWINGS

The features, aspects, and advantages of the exemplary embodiments are better understood when the following Detailed Description is read with reference to the accompanying drawings, wherein:

FIGS. 1-2 are schematics illustrating an operating environment in which exemplary embodiments may be implemented;

FIG. 3 is a schematic illustrating different packages of commands, according to exemplary embodiments;

FIG. 4 is a schematic illustrating a package generator application, according to exemplary embodiments;

FIG. 5 is a schematic illustrating a handshake process, according to exemplary embodiments;

FIGS. 6-8 are schematics illustrating a selector for the package generator application, according to exemplary embodiments;

FIGS. 9-11 are schematics illustrating a database of package generator applications, according to exemplary embodiments;

FIGS. 12-13 are schematics illustrating routing of inputs, according to exemplary embodiments;

FIGS. 14-16 are schematics illustrating an evaluation of the package generator application, according to exemplary embodiments;

FIG. 17 is a schematic illustrating automatic evaluation, according to exemplary embodiments;

FIG. 18 is a schematic illustrating a programmable controller, according to exemplary embodiments;

FIGS. 19-22 are flowcharts illustrating a method or algorithm for automated control of output devices, according to exemplary embodiments; and

FIGS. 23-24 are more schematics illustrating the programmable controller, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

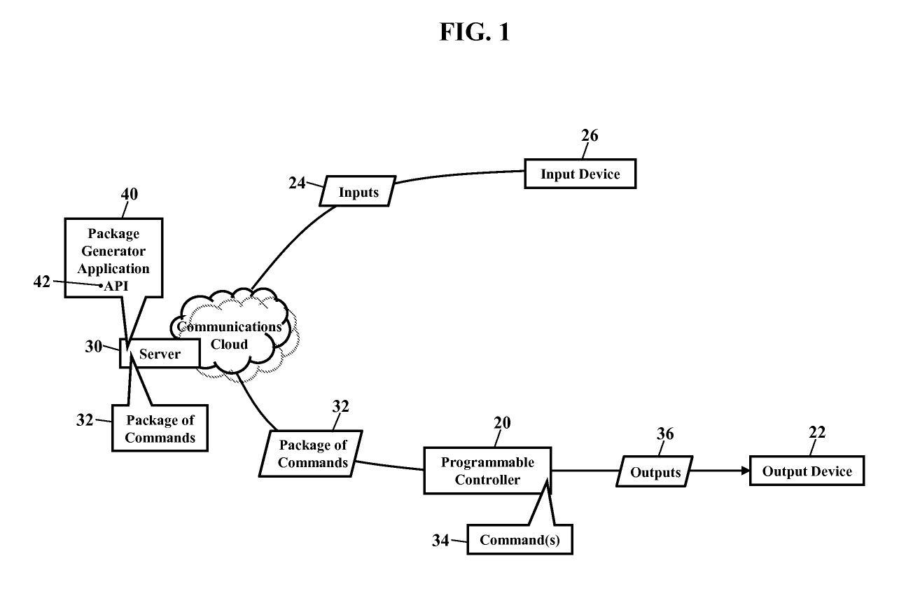

FIG. 1 is a simplified schematic illustrating an environment in which exemplary embodiments may be implemented. FIG. 1 illustrates a programmable controller 20 controlling one or more electromechanical output devices 22. The output devices 22 may be controlled based on inputs 24 received from one or more input devices 26, such as temperature sensors, pressure sensors, and position sensors. A conventional programmable controller 20 would use the inputs 24 to control the output devices 22. Exemplary embodiments, though, utilize a cloud-based control arrangement. Here the inputs 24 are sent to a separate device, such as a remote server 30. The remote server 30 uses the inputs 24 to generate a package 32 of commands. The package 32 of commands describes a sequence of one or more commands for controlling the output devices 22. Once the package 32 of commands is created, the remote server 30 sends the package 32 of commands to the programmable controller 20 for queuing and for execution. At an appropriate time, the programmable controller 20 executes one or more scheduled commands 34 to generate outputs 36. The outputs 36 control operation of the output devices 22.

In simple terms, the scheduled commands 34 may be tasks for execution. As many readers may know, the programmable controller 20 may be used to control and automate lights, thermostats, sprinklers, and other home output devices. The programmable controller 20 may also be used to control more sophisticated electromechanical machines, such as pumps, motors, and other industrial equipment. Each command 34 may thus define how and when the programmable controller 20 generates the outputs 36 to control the output devices 22. Some commands 34 may require immediate execution, while other commands 34 are queued for future execution. Regardless, each command 34, when executed, causes the programmable controller 20 to control the output device 22, such as a light, thermostat, sprinkler, or more complicated equipment.

The programmable controller 20 automates electromechanical control. The programmable controller 20 may be configured for multiple input and output arrangements, unlike a conventional digital computer. Moreover, the programmable controller 20 is more robust than a conventional computer and designed to withstand harsh industrial conditions (such as extreme temperatures, humidity, vibration, contamination, and electrical interference). Programmable controllers are generally known, though, so this disclosure will not dwell on the known aspects.

Exemplary embodiments thus describe cloud-based control of the output devices 22. The package 32 of commands is developed by an external application, such as a package generator application 40 operating in the remote server 30. The package 32 of commands may then be downloaded to the programmable controller 20 for queuing and execution. Because the package 32 of commands is remotely generated, the programmable controller 20 is thus relieved of the burden of generating the commands 34 for execution. Indeed, the programmable controller 20 may even be agnostic to the package generator application 40. Because the package generator application 40 is remotely stored and executed, the programmable controller 20 need not care about the vendor of the package generator application 40, its version, or its compatibility. The programmable controller 20 need only care that the package 32 of commands is interpretable. As long as the package 32 of commands is understandable, the programmable controller 20 is unconcerned with the package generator application 40.

A marketplace may thus develop. Because the programmable controller 20 is agnostic to the package generator application 40, vendors may develop many different packages 32 of commands for the same output devices 22. Each package 32 of commands may have different features, interfaces, and performance characteristics. The various different package generator applications 40, though, may all utilize a common set of application programming interfaces (or “APIs”) 42. The application programming interfaces 42 may define how the package 32 of commands is shared back to the programmable controller 20. While the application programming interfaces 42 may have any structure and/or definition, a simple implementation may include an extensible mark-up language (XML) structure or similar construct. So different vendors may offer different package generator applications 40, but the different package generator applications 40 may all utilize common calls and functions. As long as each package generator application 40 utilizes the common set of application programming interfaces 40, the programmable controller 20 need not care what vendor offers the package generator application 40, nor does the programmable controller 20 care about version differences. The programmable controller 20 only cares that the package 32 of commands is recognizable for execution according to the common set of application programming interfaces 40.

The application programming interfaces 40 permit importation and exportation. Because the application programming interfaces 40 may define common interfaces, the programmable controller 20 may export the package 32 of commands, and/or any individual command 34, to another software application. For example, even though the package 32 of commands is generated by the package generator application 40 in the remote server 30, the programmable controller 20 may send the package 32 of commands to a different package generator application. That is, one vendor's package generator application may read and manipulate a different vendor's package 32 of commands. The application programming interfaces 40 thus permit the package 32 of commands to be modified and returned back to the programmable controller 20 for execution. Indeed, the package 32 of commands may be imported into another piece of software, thus allowing the package 32 of commands to be merged or used with differing features. The package 32 of commands, for example, may be implemented into software that provides an improved graphical user interface, better control features, faster execution, and/or generally more desirable package management capabilities. Thanks to API definitions, the package 32 of commands may be extensible, reusable, importable, and exportable on a universal basis. If some program only implements a partial command set, then it may fail to support packages created by a program that supported more commands.

Exemplary embodiments thus describe a marketplace of package generator applications. Because the programmable controller 20 is agnostic to the package generator application 40, different vendors may vie for control of the programmable controller 20. As different package generator applications 40 are written by different vendors, the various different package generator applications 40 will have different features, performances, and interfaces. A user may thus pick-and-choose amongst different package generator applications. The user may thus evaluate each vendor's package generator application and select the offering that best suits the user's objectives.

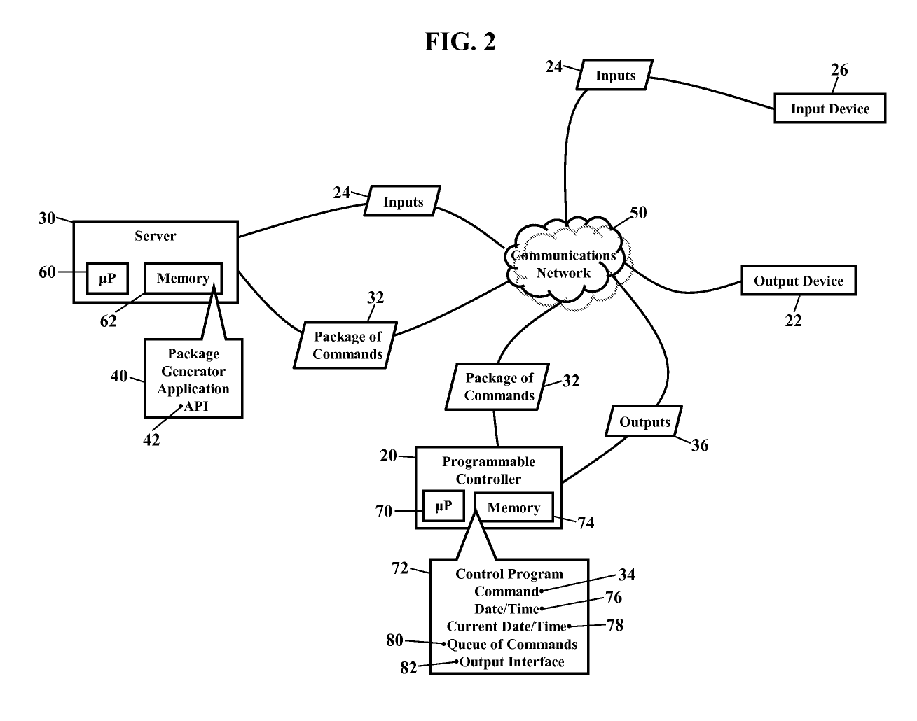

FIG. 2 is a more detailed schematic illustrating the operating environment, according to exemplary embodiments. Here the programmable controller 20 communicates with the remote server 30 using a communications network 50, such as the global Internet. The remote server 30 may also communicate with the input devices 26 using the communications network 50. For simplicity only one input device 26 is shown, but there may be several or even many input devices 26. The input device 26 monitors some condition (e.g., temperature, pressure, position) and generates the inputs 24. The inputs 24 are sent over the communications network 50 to a domain name and/or an address associated with the remote server 30. The programmable controller 20 and the remote server 30 may thus have a client-server relationship for cloud-based control of the output device 22.

The remote server 30 generates the package 32 of commands. The remote server 30 has a processor 60 (e.g., “μP”), application specific integrated circuit (ASIC), or other component that executes the package generator application 40 stored in a memory 62. The package generator application 40 is a set of programming, code, or instructions that cause the processor 60 to receive the inputs 24 and to generate the package 32 of commands. The inputs 24, the package generator application 40, and/or the package 32 of commands may utilize the application programming interfaces 42 to ensure uniformity and conformity.

The package 32 of commands is sent to the programmable controller 20. The package 32 of commands routes through the communications network 50 to a domain name and/or an address associated with the programmable controller 20. The programmable controller 20 has a processor 70 (e.g., “μP”), application specific integrated circuit (ASIC), or other component that executes a control program 72 stored in a memory 74. The control program 72 is a set of programming, code, or instructions that cause the processor 70 to queue each command 34 for execution.

The command 34 may be queued by date and time 76. Because the remote server 30 receives the inputs 24 and executes the package generator application 40, the programmable controller 20 need not analyze the inputs 24 nor generate the commands 34. The programmable controller 20 need only receive and chronologically queue the commands 34. Because the commands 34 are queued based on the event date and time 76, some commands 34 may require immediate execution. Other commands 34, though, may be calendared in the future.

The programmable controller 20 eventually executes the command 34. The programmable controller 20 has a master clock or signal that provides a current date and time 78. The control program 72 may continuously compare the current date and time 78 to a queue 80 of commands. Each command 34 in the queue 80 of commands has the associated command date and time 76. When the current date and time 78 matches any one of the command date and times 76 in the queue 80 of commands, then the corresponding command 34 is executed by the control program 72. The command 34 causes the processor 70 to generate the outputs 36 for the output devices 22. For simplicity only one output device 22 is shown, but there may be several or even many output devices 22. There may even be an output interface 82 that helps generate and configure the outputs 36. Regardless, the outputs 36 may then be sent over the communications network 50 to a domain name and/or an address associated with the output device 22. The outputs 36 control operation of the output device 22, such as closing a switch or adjusting a thermostat.

Exemplary embodiments thus describe cloud-based automation control. Because the package generator application 40 may be remotely executed by the remote server 30, the programmable controller 20 need not generate the commands 34. Indeed, the programmable controller 20 may even be agnostic to the package generator application 40. Because the package generator application 40 is remotely executed, the programmable controller 20 can be designed and manufactured with less cost. Multiple vendors may thus develop many different package generator applications 40 with different features, interfaces, and performance characteristics. The vendors may thus vie for control of the programmable controller 20, and users pick-and-choose amongst different package generator applications 40. Package generator applications 40 may thus be swapped for evaluation, without reconfiguring the programmable controller 20 or the output devices 22.

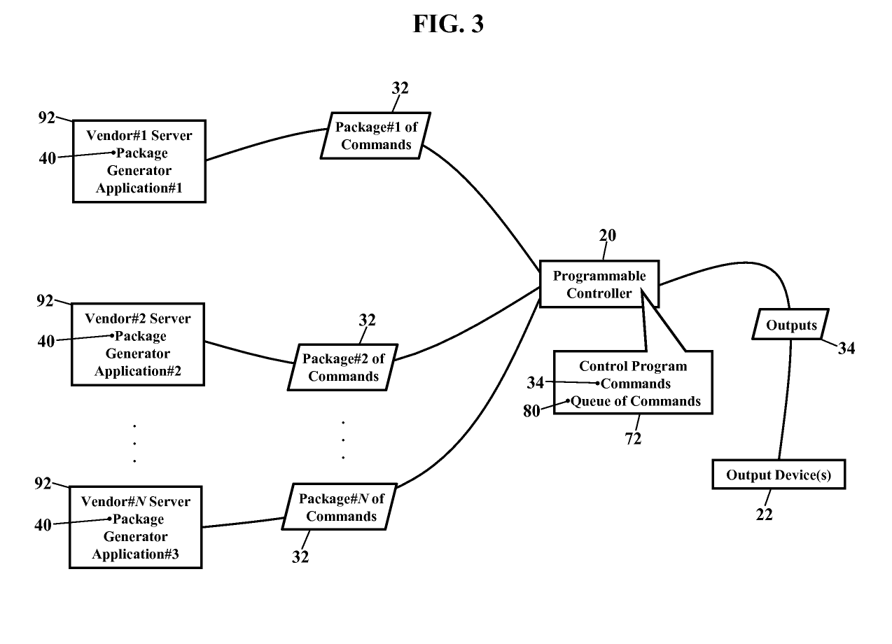

FIG. 3 is a schematic illustrating different packages 32 of commands, according to exemplary embodiments. Because the programmable controller 20 is agnostic to the package generator application 40, there may be many different package generator applications 40 that send different packages 32 of commands to the programmable controller 20. FIG. 3 thus illustrates several vendor servers 92, with each vendor server 92 executing one or more different package generator applications 40. That is, each vendor may have multiple package generator applications, and each package generator application may create one or multiple packages 32 of commands. The programmable controller 20 may thus receive multiple, different packages 32 of commands, and the programmable controller 20 still queues all the commands 34 for execution. Each command 34 in each package 32 of commands is loaded into the memory of the programmable controller 20. The individual commands 34 are aggregated and sequentially arranged in the queue 80 of commands. So, even though multiple, different packages 32 of commands may be received, all the commands 34 from all loads operate in the correct sequence. Even if a particular package 32 of commands is added or subsequently modified, the master queue 80 of commands may be re-chained or reordered to match the aggregated command list.

An example helps explain FIG. 3. Suppose the programmable controller 20 receives three different packages 32 of commands (e.g., “Package#1 of Commands,” “Package#2 of Commands,” and “Package#3 of Commands”). Package#1, for example, may instruct the programmable controller 20 to turn on “Device A” at 9 AM on Tuesdays to 80% electrical power. Package#2 instructs the programmable controller 20 to turn on “Device B” at 3 PM on Tuesdays at 100% power. Each day, or on each update, the programmable controller 20 may update its queue 80 of commands by reading all packages 32 of commands from all external sources that are stored in the memory. If a user modifies Package#1, then the programmable controller 20 may rebuild the day's consolidated action list by removing everything from stored Package#1 and then re-inserting the commands 34 from newly modified Package#1. The programmable controller 20 may continue taking actions, based on the consolidated queue 80 of commands and the current date/time. Multiple packages 32 of commands, from the same or different external programs, may thus be managed together and executed by the programmable controller 20.

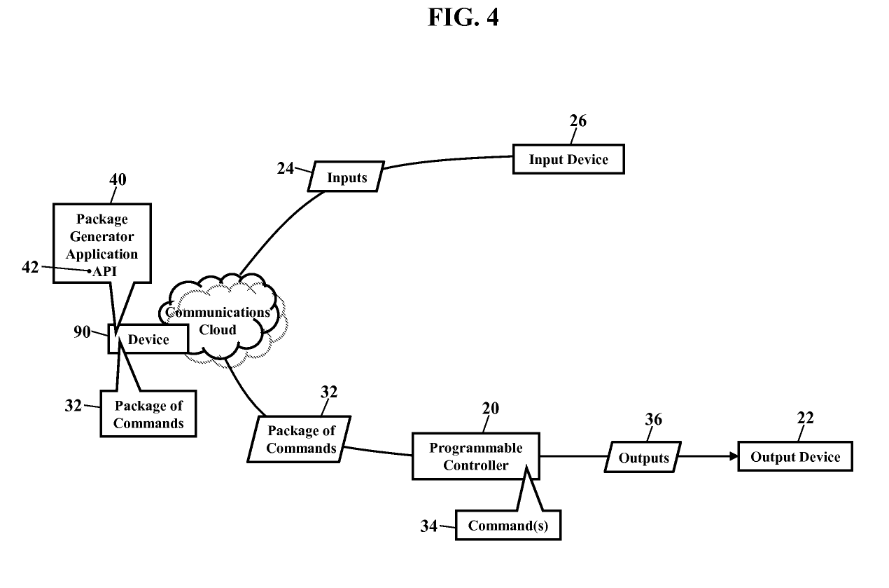

FIG. 4 is a schematic further illustrating the package generator application 40, according to exemplary embodiments. Because the programmable controller 20 is agnostic to the package generator application 40, the programmable controller 20 does not care what device generates the package 32 of commands. Again, as long as the package 32 of commands is recognizable for execution (perhaps according to the common set of application programming interfaces 40), any device may generate the package 32 of commands. FIG. 4 thus illustrates the package generator application 40 being stored and executed by any device 90. The device 90 may be a computer, smart phone, tablet, set-top box, receiver, clock, or any other processor-controlled device. As long as the package 32 of commands is recognizable for execution, the programmable controller 20 does not care what device generates the package 32 of commands.

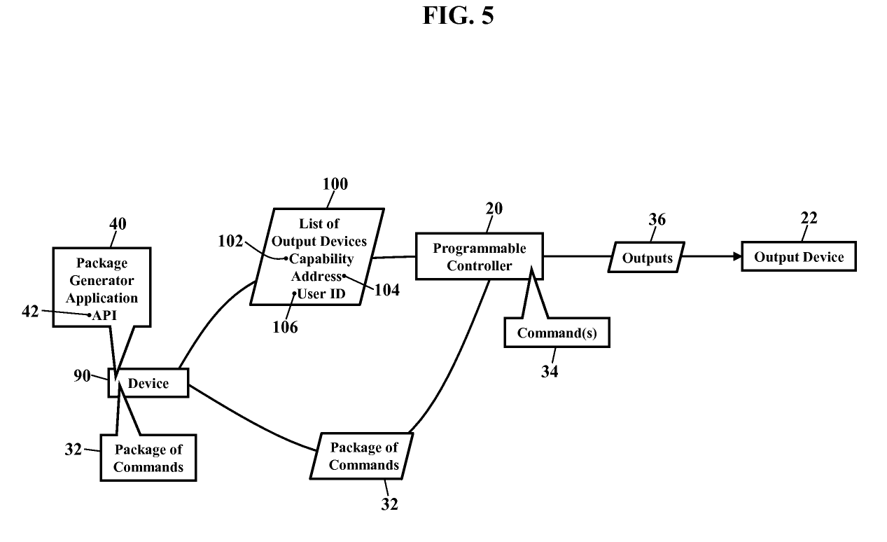

FIG. 5 is a schematic illustrating a handshake process, according to exemplary embodiments. As this disclosure has explained, the programmable controller 20 is agnostic to both the package generator application 40 and the device 90 that generates the package 32 of commands. Exemplary embodiments may thus utilize a handshake process to ensure the programmable controller 20 responds to the package 32 of commands. As FIG. 5 illustrates, the programmable controller 20 may send a list 100 of the output devices 22 under its control. Each output device 22, for example, may be identified by a manufacturer and/or model number and/or a user-assigned name (such as “back door lock” or “pump 2”). Regardless, the programmable controller 20 may also send a device capability 102 associated with each output device 22. Alternatively, once the manufacturer and/or model number is known, the package generator application 40 may query a database for the device capability 102 associated with each output device 22. The programmable controller 20 may thus send the list 100 of the output devices 22 in the home or business and any information about their capabilities. The list 100 of the output devices 22, for example, may be an XML device descriptor list created by the programmable controller 20 and shared with the package generator application 40. The package generator application 40 may even have editing permissions and capabilities, thus allowing a user of the programmable controller 20 to edit the list 100 and add/delete output devices 22. The programmable controller 20 may also send a communications address 104 (e.g., Internet Protocol address and/or a domain name) assigned to the programmable controller 20. The package generator application 40 may thus generate the package 32 of commands to be consistent with the device capability 102 associated with each output device 22. The package 32 of commands is then sent to the communications address 104 assigned to the programmable controller 20. The handshake process thus ensures the external package generator application 40 has security credentials to access the programmable controller 20 and to manipulate the package 32 of commands.

Exemplary embodiments may also send a user identification 106. Different users of the programmable controller 20 may have different permissions to different capabilities. Some features in the programmable controller 20 may be restricted and only available to administrators or other authorized users. Other features may be more generally available to most or all users. Regardless, the user identification 106 helps the external package generator application 40 segregate users and features when controlling the output devices 22.

Exemplary embodiments thus do not require Internet access for execution of commands 34. Because the external package generator application 40 generates the package 32 of commands, network access is not required for execution of the commands 34. The programmable controller 20 only needs quick access to receive the package 32 of commands. Once the package 32 of commands is received, the various commands 34 are executed without further network access. The package 32 of commands is stored in the local memory of the programmable controller 20, so the programmable controller 20 does not require live network access for sequence execution. The package 32 of commands is stored in the programmable controller 20, managed external to the programmable controller 20, but executed from within the programmable controller 20, so the commands 34 can run even when a network is down/unavailable.

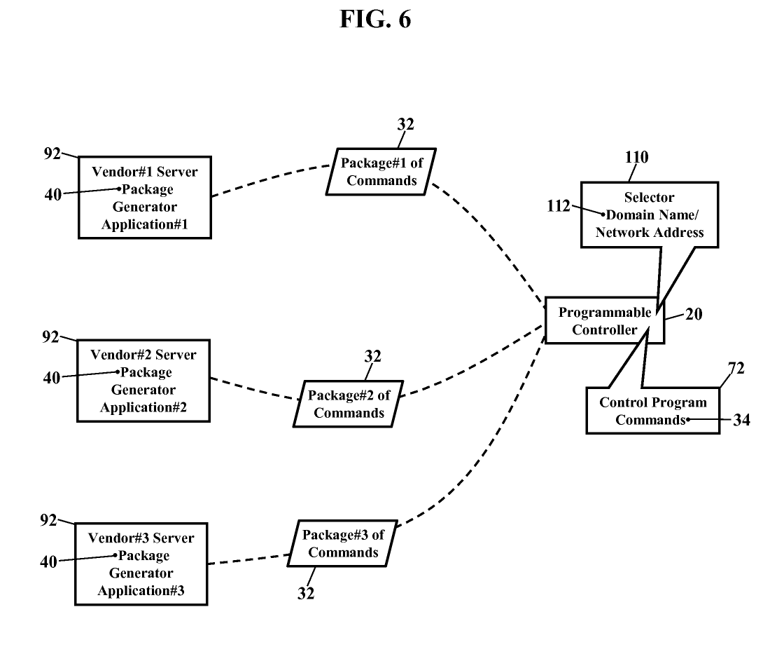

FIGS. 6-8 are schematics illustrating a selector 110 for the package generator application 40, according to exemplary embodiments. As earlier paragraphs explained, there may be many different package generator applications 40. The various package generator applications 40 may compete for control of the programmable controller 20. FIG. 6 thus again illustrates the several vendor servers 92, with each vendor server 92 executing a different package generator application 40. Each different package generator application 40 may generate a different package 32 of commands. The commands 34, though, may differ, depending on the package generator application 40. As the different package generator applications 40 may have different features (perhaps depending on the vendor), the commands 34 generated by different package generator applications 40 may have different parameters. One vendor's commands 34, in other words, may have a different look, feel, and performance when compared to another vendor's commands 34. A user of the programmable controller 20 may thus want to ensure that their desired vendor's package generator application 40 is always executed. If the wrong package generator application 40 is executed, the output devices 22 may not perform as intended. Indeed, in an industrial facility, lives may be at risk.

The selector 110 thus ensures that the correct package generator application 40 is executed. The selector 110 determines which one of the many package generator applications 40, offered by many different vendors, is executed to generate the commands 34. The selector 110 is illustrated as being locally stored and executed in the programmable controller 20, but the selector 110 may be remotely stored and accessed from any location in the communications network (illustrated as reference numeral 50 in FIG. 2). The selector 110 is a set of programming, code, or instructions that determine which package 32 of commands, from different package generator applications 40, should be executed by the programmable controller 20. Because there may be many different package generator applications 40 that compete for control of the programmable controller 20, the selector 110 may store some network identifier associated with the chosen package generator application 40. That is, when the user of the programmable controller 20 makes a selection, selects a particular vendor's package generator application 40, the corresponding network identifier, from which the selected package generator application 40 is accessed, may be logged for processing. The network identifier may be any descriptor, such as a domain name and/or network address 112 associated with the chosen package generator application 40. That is, when the user of the programmable controller 20 selects a particular vendor's package generator application 40, the corresponding domain name and/or network address 112 may be logged for processing. The domain name and/or network address 112 thus points to or identifies the machine, domain, or other network location at which the desired package generator application 40 is executed. If the package 32 of commands is not received from, or associated with, the domain name and/or network address 112, the programmable controller 20 may reject receipt and/or execution. The control program 72, in other words, may be authorized to only execute commands 34 received from, or associated with, a particular machine, domain, or entity.

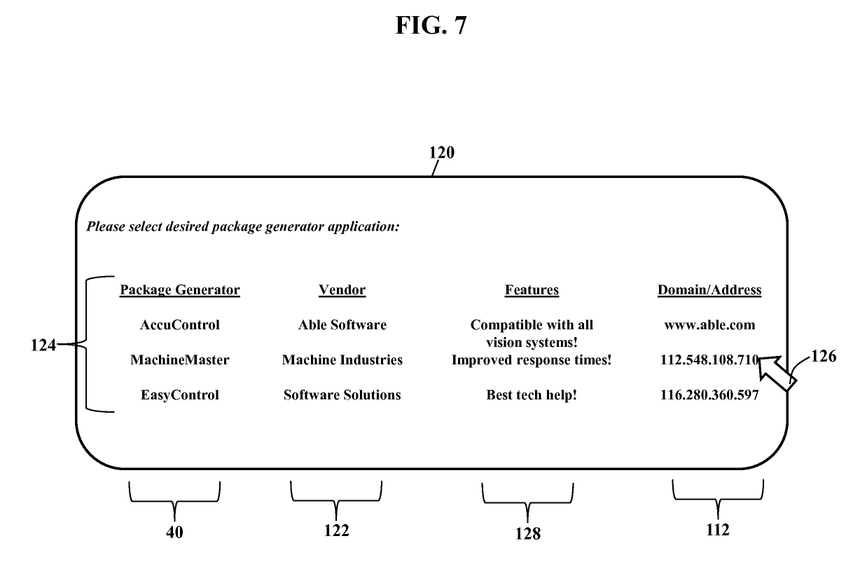

FIG. 7 thus illustrates a graphical user interface 120. The graphical user interface 120 graphically illustrates the various different package generator applications 40 offered by different vendors 122. The graphical user interface 120 thus presents a menu 124 of package generator applications. A user may position a cursor 126 and click or otherwise select their desired package generator application 40. The corresponding domain name and/or network address 112 may then be stored for processing.

The menu 124 of package generator applications may even aid the user's selection. As FIG. 7 illustrates, the menu 124 of package generator applications may present informational fields 128 that describe features, performances, and/or comparisons. Vendors may thus describe their respective package generator application 40, and include product descriptions and comparisons to help persuade the user. The menu 124 of package generator applications may even include promotions and advertising to entice users to try different package generator applications 40.

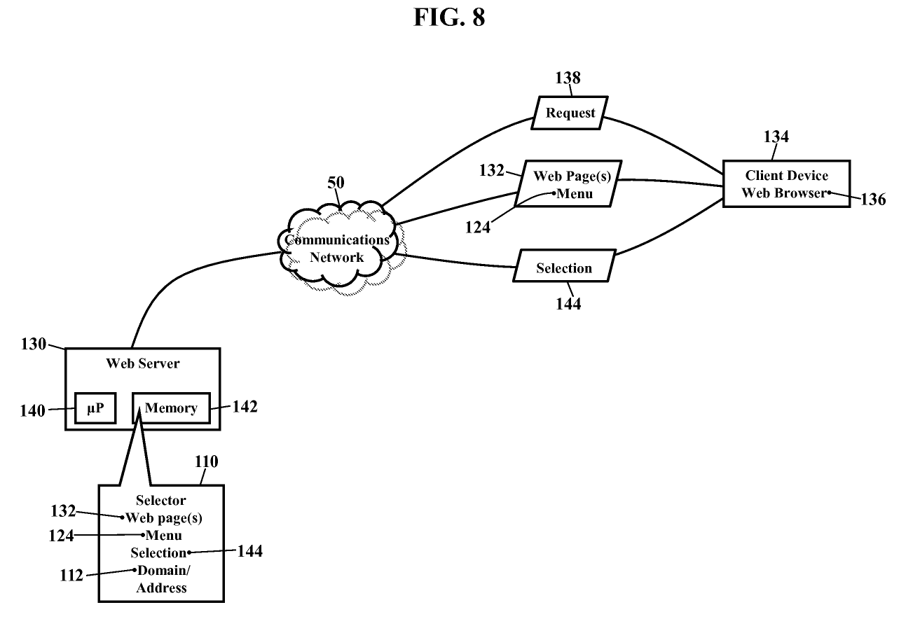

FIG. 8 illustrates a web embodiment of the selector 110. Here the selector 110 is stored in a web server 130 as one or more web pages 132. A user, from any client device 134, may query the web server 130 for the menu 124 of package generator applications. That is, a web browser 136 stored in memory of the client device 134 causes a client processor to send a request 138 for the menu 124 of package generator applications. A processor 140 in the web server 130 retrieves the corresponding web pages 132 from memory 142 and returns the corresponding web pages 132 to the client device 134. The client device 134 visually presents the web pages 132, thus allowing the user to view the menu 124 of package generator applications. The user makes a selection 144, and the selection 144 is sent to the web server 130. The selector 110 then stores the corresponding domain name and/or network address 112 for processing. Exemplary embodiments thus include a web site, accessible from any web browser 136, that lists or links to one or more package generator applications. A user may merely search for the web pages 132 describing or linking to the package generator application (illustrated as reference numeral 40 in FIGS. 1-7).

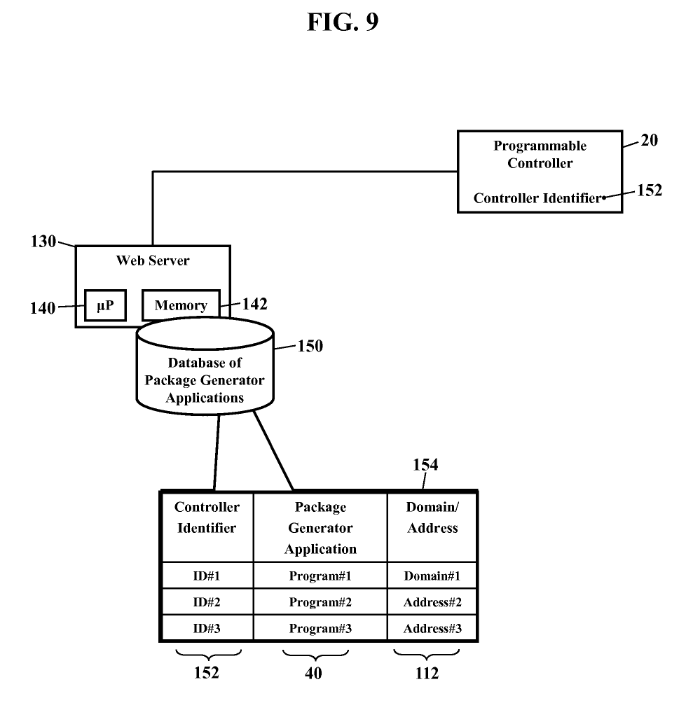

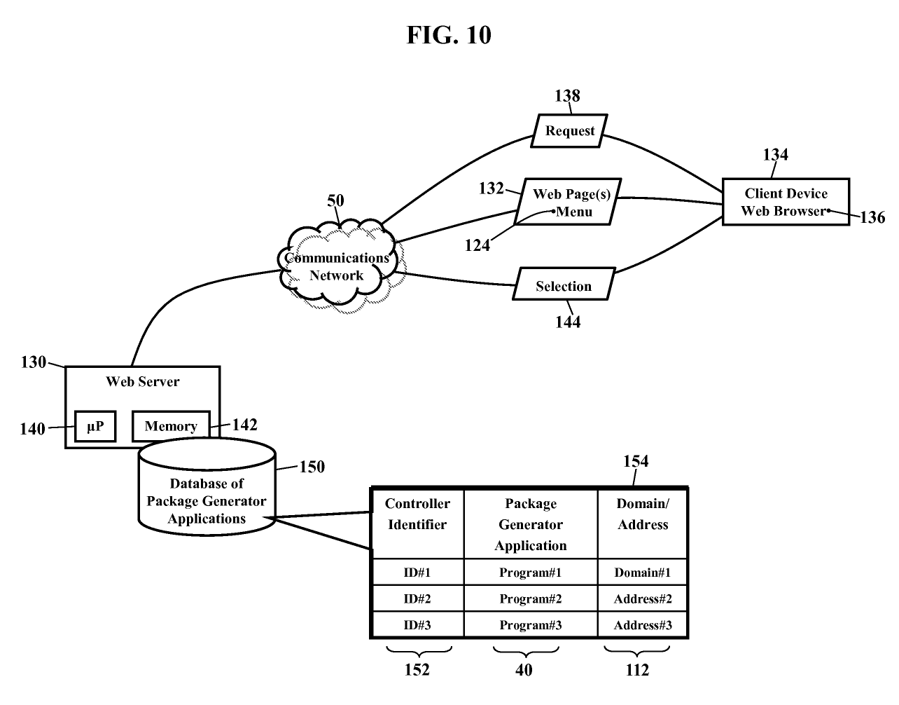

FIGS. 9-10 are schematics illustrating a database 150 of package generator applications, according to exemplary embodiments. Because there may be many vendors of many package generator applications 40, exemplary embodiments include a centralized repository of programmable controllers and their corresponding package generator application 40. Hundreds, even millions, of customers may purchase the cloud-controlled programmable controller 20, and those customers may all choose from different vendors of the package generator application 40. The database 150 of package generator applications thus represents a centralized location that stores these records to ensure each customer's desired package generator application 40 is correctly executed. For simplicity, FIG. 9 illustrates the database 150 of package generator applications being stored in the memory 142 of the web server 130. The database 150 of package generator applications, however, may be stored and accessed from any networked device.

The database 150 of package generator applications associates programmable controllers to control programs. Each different programmable controller 20 is identified by a controller identifier 152. The controller identifier 152 may be any unique alphanumeric combination that differentiates the programmable controller 20 from all other programmable controllers. The controller identifier 152, for example, may be a machine serial number, a machine address, or an IP address. Each programmable controller 20 sends its assigned controller identifier 152 to the domain name and/or address associated with the web server 130. The database 150 of package generator applications adds an entry for the controller identifier 152.

The database 150 of package generator applications associates the corresponding domain name and/or network address 112. When the database 150 of package generator applications receives the controller identifier 152, the database 150 of package generator applications also logs or tracks each corresponding package generator application 40 associated with the programmable controller 20. FIG. 9 thus illustrates the database 150 of package generator applications as a table 154 that maps, relates, lists, or associates the controller identifier 152 to the domain name and/or network address 112 of the corresponding package generator application 40. So, whenever exemplary embodiments need to determine the correct package generator application 40 for any of the programmable controllers 20, exemplary embodiments need only query the database 150 of package generator applications for the controller identifier 152. The database 150 of package generator applications may then respond with the corresponding domain name and/or network address 112.

FIG. 10 thus illustrates automatic updates to the database 150 of package generator applications. Here again the database 150 of package generator applications is illustrated as being locally stored and maintained in the web server 130. When the menu 124 of package generator applications is sent as the web pages 132 to the client device 134, the client device 134 responds with the user's selection 144 of the desired package generator application 40. The selection 144 may specify or identify the corresponding domain name and/or network address 112 of the selected package generator application 40. The selection 144 may additionally or alternatively identify a name or other unique identifier associated with the desired package generator application 40. Regardless, exemplary embodiments automatically update the database 150 of package generator applications with the user's selection 144. That is, the database 150 of package generator applications adds or modifies an entry in the list to associate the corresponding controller identifier 152 to the corresponding domain name and/or network address 112 of the package generator application 40.

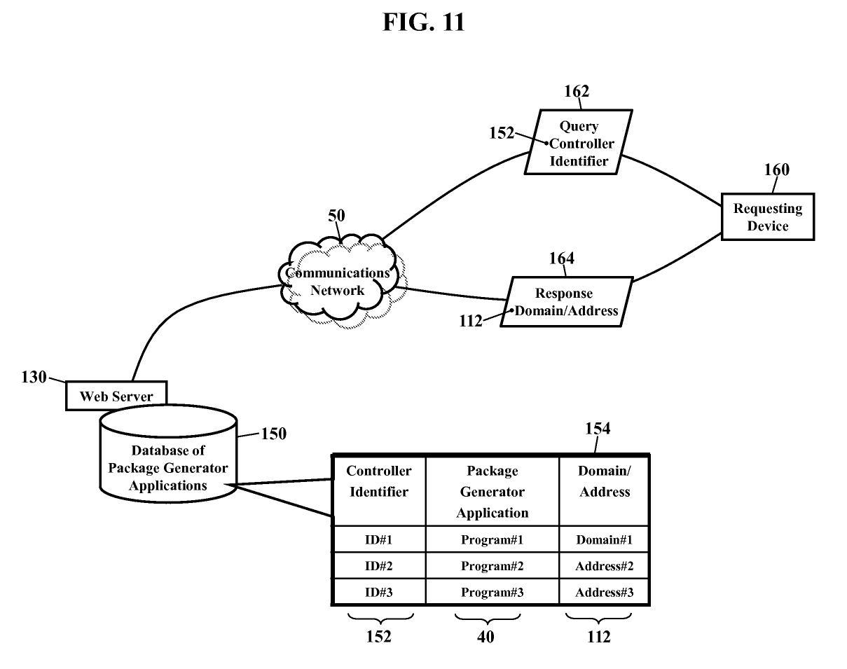

FIG. 11 is a schematic further illustrating the database 150 of package generator applications, according to exemplary embodiments. Because the database 150 of package generator applications may be a central repository of programmable controllers and their corresponding package generator application 40, the database 150 of package generator applications may be queried for the domain name and/or network address 112. As FIG. 11 illustrates, any requesting device 160 may send a query 162 to the domain name and/or address associated with the web server 130 hosting the database 150 of package generator applications. The requesting device 160 is only generically illustrated, as the requesting device 160 may be any processor-controlled device (such as a computer, router, or smart phone). If the query 162 specifies the controller identifier 152 of interest, then the database 150 of package generator applications retrieves the corresponding domain name and/or network address 112. The query 162, however, may also be a reverse lookup in which the database 150 of package generator applications retrieves the controller identifier 152 associated with the domain name and/or network address 112. Regardless, the web server 130 sends a response 164 to the domain and/or address associated with the requesting device 160. So, whenever routing records are needed, the database 150 of package generator applications may be queried for the quick response 164.

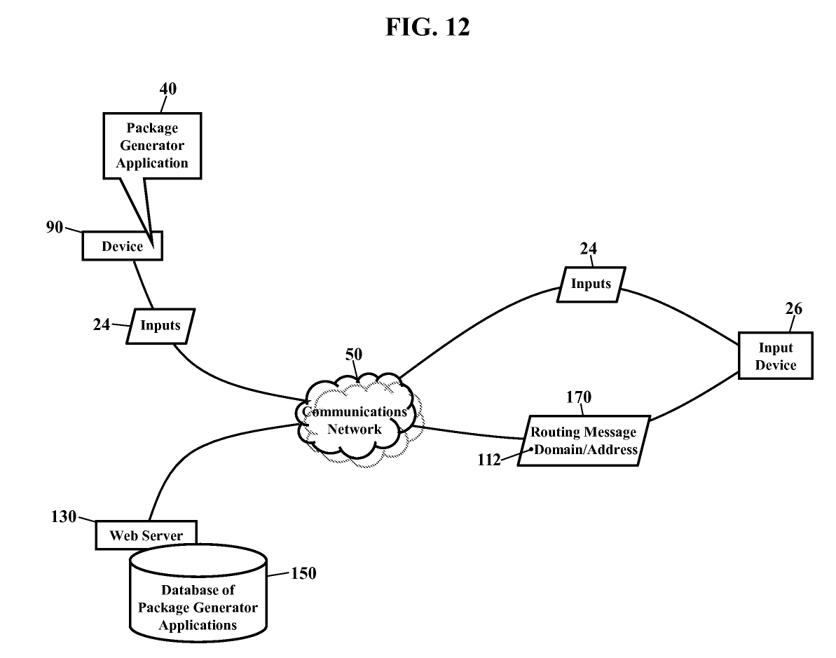

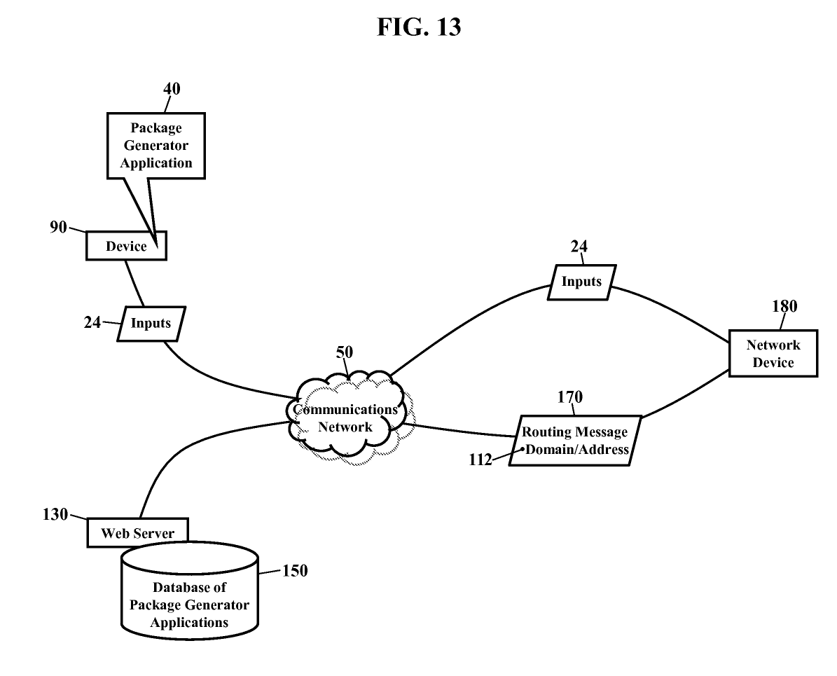

FIGS. 12-13 are schematics illustrating routing of the inputs 24, according to exemplary embodiments. Once the domain name and/or network address 112 of the desired package generator application 40 is known, the input devices 26 may be informed. As earlier paragraphs explained, the input devices 26 may send the inputs 24 to the device 90 executing the desired package generator application 40. The input devices 26, then, may need to be informed of the correct domain name and/or network address 112 associated with the executing device 90. FIG. 12 thus illustrates a routing message 170 sent from the database 150 of package generator applications. That is, once the database 150 of package generator applications is updated, the database 150 of package generator applications may be used to inform any of the input devices 26. The web server 130, for example, may execute programming code or instructions that send the routing message 170 to the input devices 26. The routing message 170 instructs the input devices 26 to send the inputs 24 to the domain name and/or network address 112 associated with the desired package generator application 40.

The inputs 24, though, could be received at the programmable controller 20. The input devices 26 may feed the programmable controller 20 with analog or digital data, and the programmable controller 20 may forward the inputs 24 to the domain name and/or network address 112 associated with the desired package generator application 40. The programmable controller 20, as an example, may subscribe to and notify a particular package generator application 40. The programmable controller 20 may even process the input 24, such as analog to digital conversion, scaling, or any other operation. If, however, the programmable controller 20 sends the inputs 24 to the desired package generator application 40, regular or periodic network access may be required. Additionally or alternatively, an application programming interface (illustrated as reference numeral 40 in FIGS. 1-2 & 4-5) may include logical statements that specify under what conditions the package generator application 40 wants to be notified of input values. This scenario allows for simpler input devices 26 and reduced network load for input distribution back to the desired package generator application 40.

FIG. 13 is similar, but here a network device 180 is updated. Sometimes routers, edge servers, and/or any other network devices 180 need to also be updated with the domain name and/or network address 112. Exemplary embodiments may thus additionally or alternatively send the routing message 170 to the generically-illustrated network device 180. The routing message 170 instructs the network device 180 to forward, route, or otherwise send the inputs 24 to the domain name and/or network address 112 associated with the desired package generator application 40.

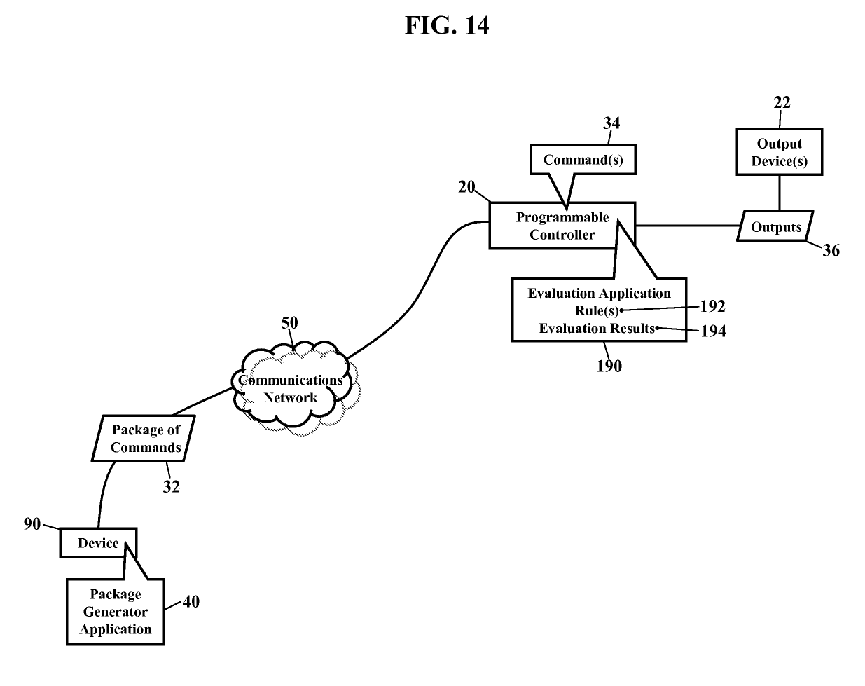

FIGS. 14-16 are schematics illustrating an evaluation of the package generator application 40, according to exemplary embodiments. As earlier paragraphs explained, because the package generator application 40 is cloud-based, the programmable controller 20 is agnostic to the package generator application 40 and to the device 90 executing the package generator application 40. The programmable controller 20 only cares that the package 32 of commands is interpretable. Multiple vendors may thus develop many different package generator applications, with each having different features, interfaces, and performance characteristics. A user or administrator of the programmable controller 20 may thus pick-and-choose amongst different package generator applications (as illustrated with reference to FIGS. 6-8). Exemplary embodiments thus allow different package generator applications to be swapped for evaluation, without reconfiguring the programmable controller 20 or the output devices 22.

The many different package generator applications may be evaluated. FIG. 14 illustrates an evaluation application 190 stored in the programmable controller 20. The evaluation application 190, however, may alternatively be remotely stored and maintained by some other device (such as the device 90, the web server 130, and/or the network device 180). The evaluation application 190 evaluates the package 32 of commands, and/or any individual command 34, according to one or more rules 192. Each rule 192 may be any logical relationship, threshold, or measure for evaluating the package 32 of commands and/or any individual command 34. Because parameters in the commands 34 may differ between different vendor's package generator application 40, the package 32 of commands may be evaluated to determine how the different vendor's programs compare. The rules 192, for example, may determine a response time for an individual command 34, an accuracy in machine movement, or even unintended consequences. Whatever the rules 192 measure, the evaluation application 190 may performance measure the commands 34 and/or the outputs 36 generated from the commands 34. The evaluation application 190 may then generate evaluation results 194.

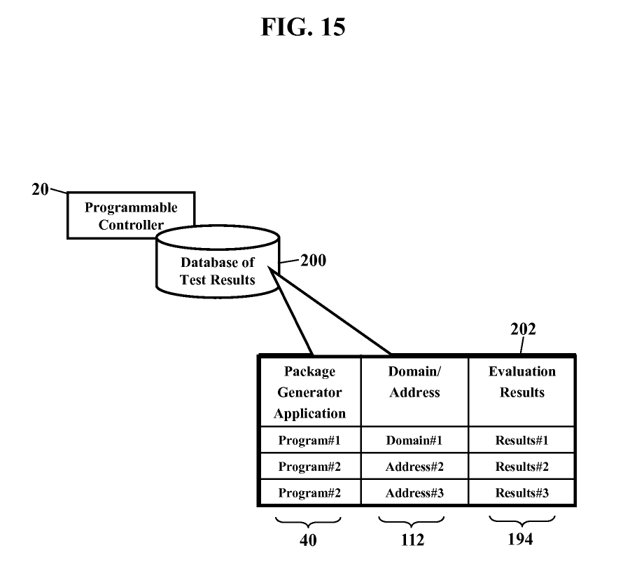

FIG. 15 illustrates a database 200 of test results. Because there may be many different package generator applications 40 from which to choose, exemplary embodiments may store and compare the evaluation results 194 generated from different vendor's programs. The database 200 of test results is illustrated as being locally stored in the programmable controller 20, yet the database 200 of test results may be remotely stored and maintained. Regardless, the database 200 of test results stores the evaluation results 194 generated from each different package generator application 40. FIG. 15 thus illustrates the database 200 of test results as a table 202 that maps, relates, or associates the package generator application 40 to its corresponding evaluation results 194. As different package generator applications 40 are used or evaluated, exemplary embodiments may store and track the different evaluation results 194 produced from the corresponding package generator application 40.

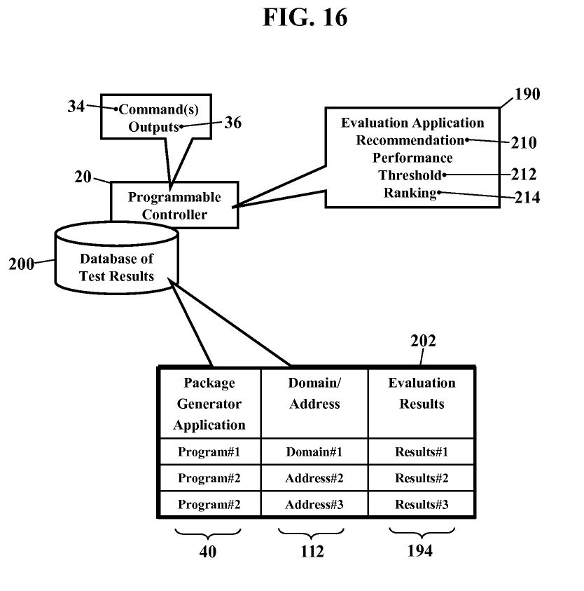

FIG. 16 further illustrates the evaluation application 190. As the database 200 of test results grows, multiple entries will contain evaluation results 194 generated from several or even many different package generator applications 40. Most users, then, will appreciate some automatic decision or recommendation 210 on which vendor's package generator application 40 is preferred. The evaluation application 190, then, may also access one or more performance thresholds 212. Each performance threshold 212 describes some maximum value, minimum value, or range of values for sorting or filtering the evaluation results 194. The evaluation results 194, generated from each different package generator application 40, may be compared to the performance thresholds 212. The evaluation application 190 may then arrange a ranking 214 of the different package generator application 40, based on the comparisons. The evaluation application 190 may then choose or recommend one of the package generator applications 40 that best satisfies the performance thresholds 212. The evaluation application 190 may thus make the formal recommendation 210 that best matches the performance thresholds 212.

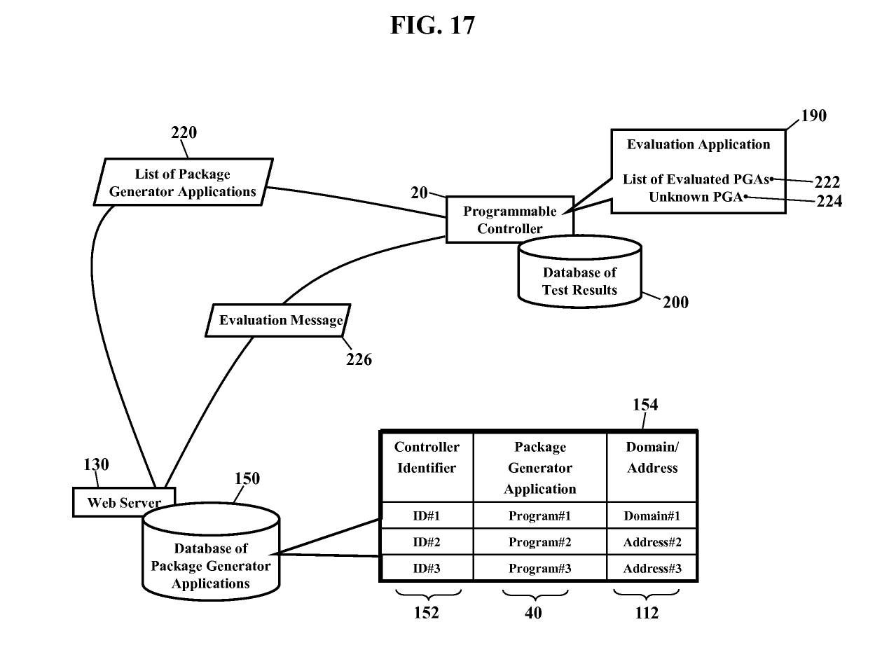

FIG. 17 is a schematic illustrating automatic evaluation, according to exemplary embodiments. Because there may be many different package generator applications 40, offered by many different vendors, exemplary embodiments may automatically evaluate each vendor's offerings. FIG. 17, then, again illustrates the database 150 of package generator applications. As previous paragraphs explained, the database 150 of package generator applications may maintain a complete listing of all the different package generator applications 40 available to the programmable controller 20. Here, then, the evaluation application 190 may also track which package generator application 40 has already been evaluated. If a particular package generator application 40 is unknown to, or untested by, the evaluation application 190, then the evaluation application 190 may want to automatically evaluate that unknown/untested package generator application 40.

The evaluation application 190 may thus query the database 150 of package generator applications for all the different package generator applications 40 available for evaluation. The control program selector 110 responds with a list 220 of package generator applications (“PGAs”). Each entry in the list 220 of package generator applications describes a different package generator application 40 that may be evaluated for potential sale, lease, or subscription. When the evaluation application 190 receives the list 220 of package generator applications, the evaluation application 190 inspects for one or more unknown/untested package generator application 224. That is, the evaluation application 190 inspects the list 220 of package generator applications for entries that have not been previously evaluated. The evaluation application 190 compares the list 220 of package generator applications to a stored list 222 of evaluated package generator applications (“PGAs”).

The evaluation application 190 may thus discover and evaluate an unknown package generator application 224. As the evaluation application 190 compares the list 220 of package generator applications to the stored list 222 of evaluated package generator applications, any mismatches may be flagged for evaluation. The evaluation application 190 may thus send an evaluation message 226 to the database 150 of package generator applications. As earlier paragraphs explained, the database 150 of package generator applications is a centralized repository of programmable controllers and their corresponding package generator application 40. The evaluation message 226 instructs the database 150 of package generator applications to associate the controller identifier 152 of the programmable controller 20 to the domain name and/or network address 112 of the unknown/untested package generator application 224. The database 150 of package generator applications thus updates its records, so that the inputs from the input devices (illustrated as reference numerals 24 and 26 in FIGS. 1-2, 4, & 12-13) are routed to the domain name and/or network address 112 associated with the unknown/untested package generator application 224. The unknown/untested package generator application 224 may then be executed to generate its commands 34 for evaluation, as earlier paragraphs explained.

Referencing FIG. 16, the unknown package generator application 224 may be evaluated. Once the unknown package generator application 224 sends its corresponding package 32 of commands, the evaluation application 190 may perform its evaluation. The evaluation application 190 may performance measure the commands 34 and/or the outputs 36 generated by the unknown/untested package generator application 224. The evaluation results 194 may also be stored in the database 200 of test results and compared to the performance thresholds 212. The evaluation results 194 may then be compared to other tested programs, perhaps again by the ranking 214. If the unknown/untested package generator application 224 performs better than others, the evaluation application 190 may then make the recommendation 210 for swapping or switching to the unknown/untested package generator application 224.

The evaluation application 190 may conduct a periodic evaluation of different package generator applications 40. As more and more vendors develop package generator applications, the evaluation application 190 may periodically evaluate the vendor's offerings. Existing vendors may routinely update their existing programs with new features, and new vendors may enter the marketplace with new programs. Exemplary embodiments may thus randomly or periodically query the database 150 of package generator applications for the list 220 of package generator applications. The evaluation application 190, for example, may query the database 150 of package generator applications every thirty (30) days to acquire any unknown/untested package generator applications 224. A user may even configure the evaluation application 190 according to some configurable, recurring time period. Regardless, the list 220 of package generator applications may then be compared to the stored list 222 of evaluated package generator applications. Any mis-matching entry identifies the unknown/untested program 224 that needs to be evaluated.

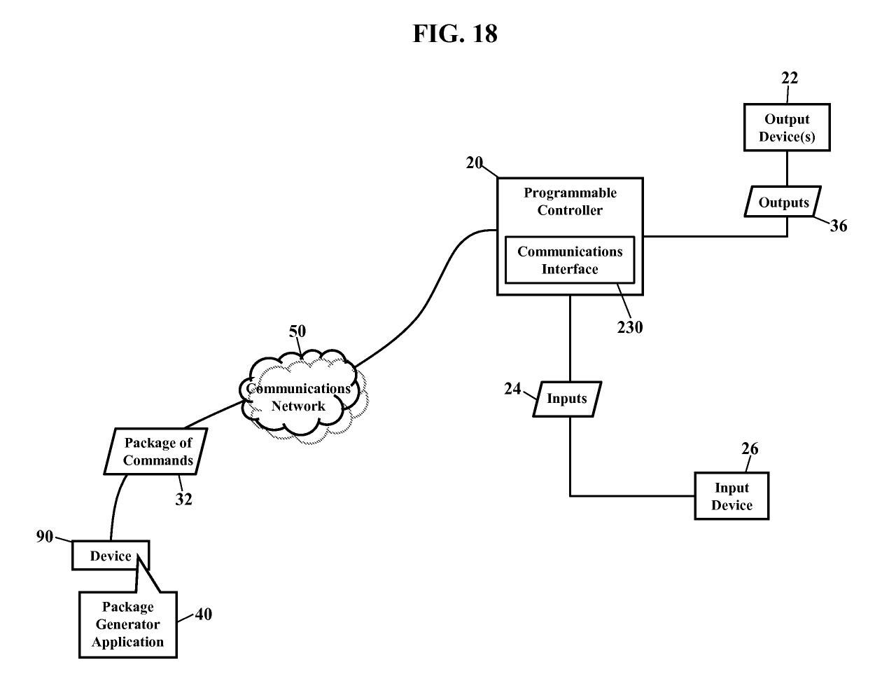

FIG. 18 is a schematic further illustrating the programmable controller 20, according to exemplary embodiments. Here the programmable controller 20 may physically or wirelessly receive the inputs 24 and/or the package 32 of commands. The programmable controller 20 may also physically or wirelessly sends the outputs 36 to the output device 22. The programmable controller 20 may thus have a communications interface 230 that establishes communication with the communications network 50, the input device 26, the device 90, and/or the output device 22. The communications interface 230 may establish communication over a physical connection (such as a cable) or a wireless medium using a wireless transmitter and/or receiver (“transceiver”). Indeed, exemplary embodiments may use any means of wired and/or wireless transmission and/or reception of signals.

Exemplary embodiments may be applied regardless of networking environment. The communications network 50 may utilize any portion of the electromagnetic spectrum and any signaling standard (such as any of the I.E.E.E. 802 family of standards, GSM/CDMA/TDMA or any cellular standard, and/or the ISM band). The communications network 50, for example, may utilize near field, BLUETOOTH®, or WI-FI® communications to establish or convey communications. The communications network 50 may also utilize a radio-frequency domain and/or an Internet Protocol (IP) domain. The communications network 50, however, may also include a distributed computing network, such as the Internet (sometimes alternatively known as the “World Wide Web”), an intranet, a local-area network (LAN), and/or a wide-area network (WAN). The communications network 50 may also have physical components, such as wires and cables. Indeed, exemplary embodiments may be applied to any wireless/wireline communications network, regardless of physical componentry, physical configuration, or communications standard(s).

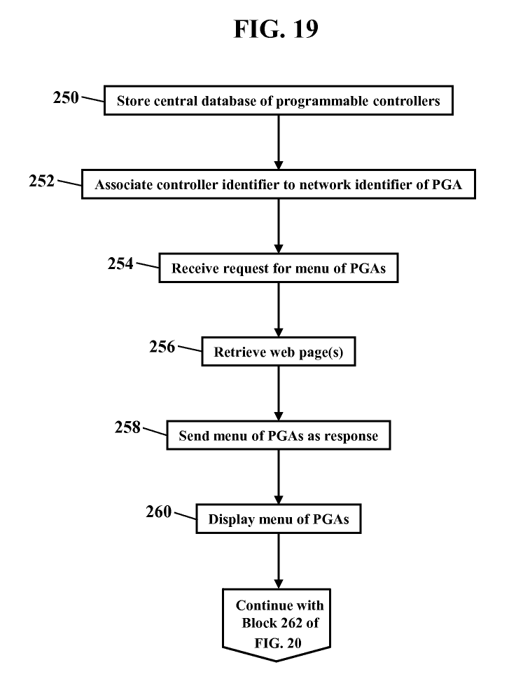

FIGS. 19-22 are flowcharts illustrating a method or algorithm for automated control of output devices, according to exemplary embodiments. A central database of programmable controllers is stored (Block 250). Controller identifiers are associated to domain names and/or network addresses of package generator applications (“APIs”) for controlling programmable controllers (Block 252). A request is received for a menu of package generator applications (Block 254). When the menu of package generator applications is web-based, at least one web page is retrieved (Block 256). A response is sent with the menu of package generator applications (Block 258). The menu of package generator applications is displayed (Block 260).

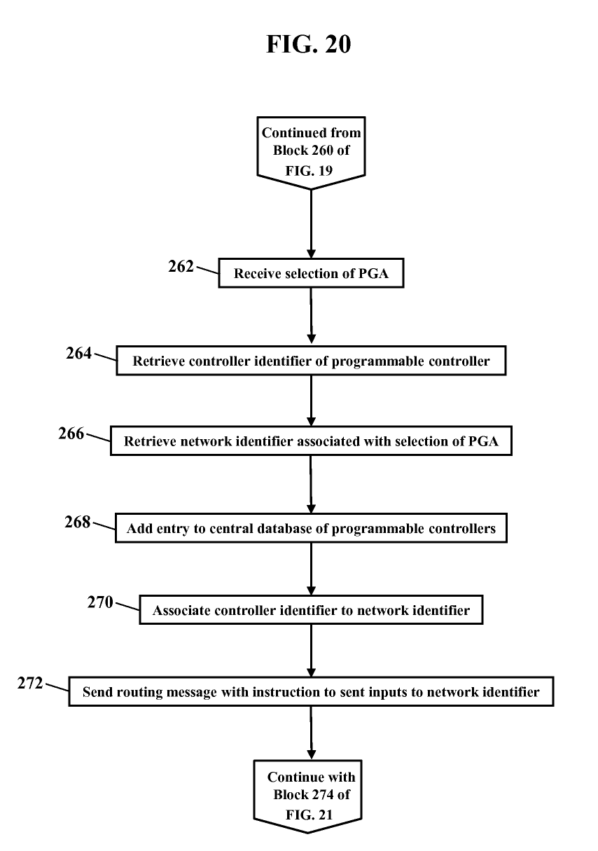

The flowchart continues with FIG. 20. A selection of a package generator application from the menu is received (Block 262). A controller identifier of one of the programmable controllers is retrieved (Block 264), and the domain name and/or network address associated with the selection of the package generator application is retrieved (Block 266). An entry is added in the central database of programmable controllers (Block 268), and the controller identifier is associated to the domain name and/or network address in the entry (Block 270). A routing message is sent that instructs a network device to sent inputs to the domain name and/or network address (Block 272).

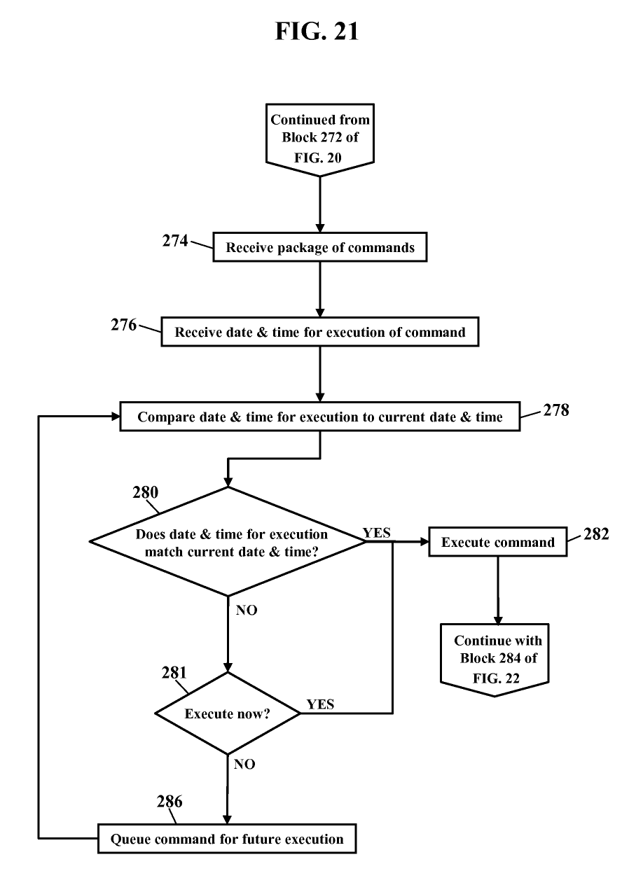

The flowchart continues with FIG. 21. A package of commands is received (Block 274). A date and time for execution of a command is also received (Block 276). The date and time for execution is compared to a current date and time (Block 278). If the date and time for execution matches the current date and time (Block 280), then the command is executed (Block 282). If, however, the date and time for execution fails to match the current date and time (Block 280), then the command is checked for an “execute now” moniker (Block 281). Some commands may be delayed in transmission, thus arriving after the current date and time. Or timing clocks/signals may be misaligned. Regardless, some wildcard, tag, or metadata may instruct the programmable controller to execute a command upon receipt (e.g., a one-time “do now” command). If the command is not associated with immediate execution (Block 281), then the command is queued for future execution (Block 282).

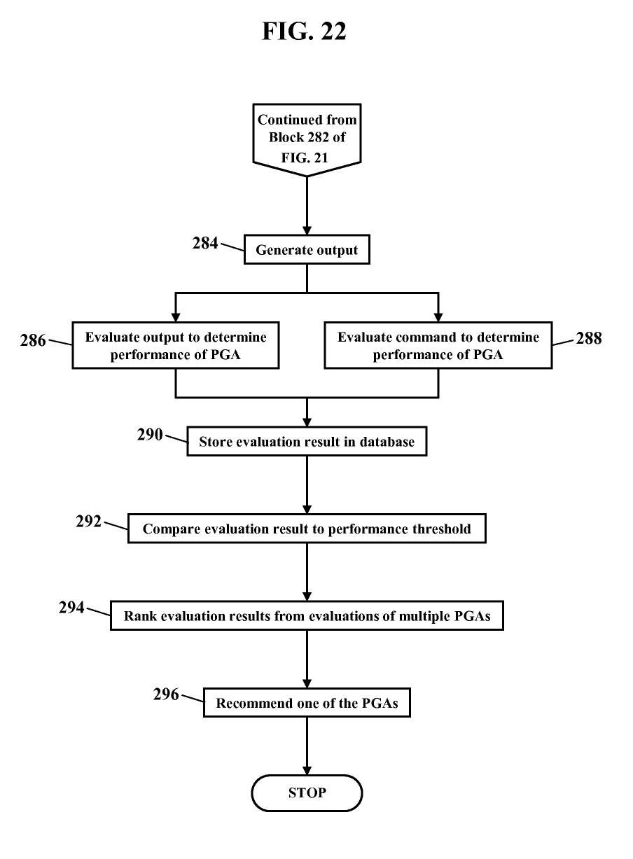

The flowchart continues with FIG. 22. Once the package 32 of commands is executed, the outputs are generated by the programmable controller (Block 284). The outputs (Block 286) and/or the package 32 of commands (Block 288) are evaluated to determine a performance of the package generator application (“API”). An evaluation result is stored in a database (Block 290) and compared to a performance threshold (Block 292). Evaluation results from multiple evaluations of multiple package generator applications may be ranked (Block 294). One of the package generator applications may be recommended, based on the ranking (Block 296).

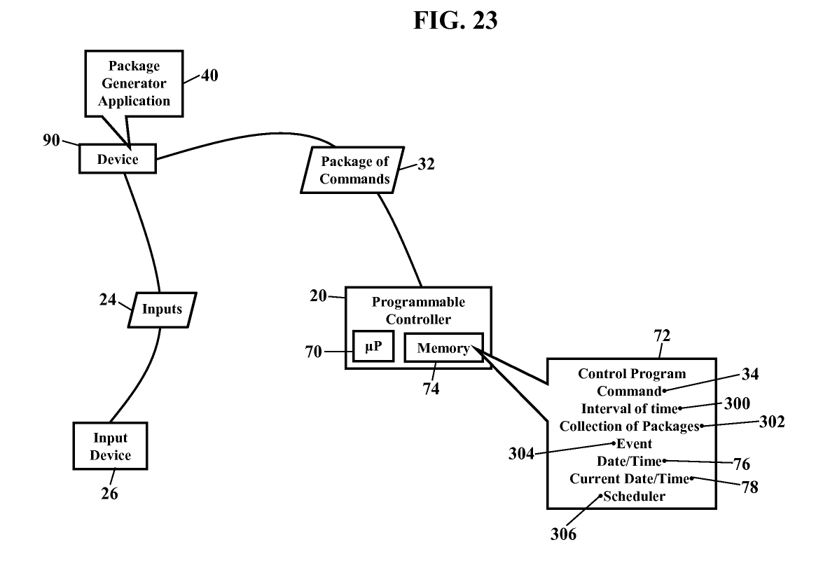

FIG. 23 is a schematic further illustrating the programmable controller 20, according to exemplary embodiments. Here the programmable controller 20 still receives the package 32 of commands, but the programmable controller 20 periodically evaluates the package 32 of commands for execution. The package 32 of commands may comprise logical conditions and/or the commands 34 that may be evaluated at any interval 300 of time. That is, the package 32 of commands is remotely created and, once received, executed in isolation by the programmable controller 20. There is no need for dialogue with the cloud-based device 90 (that generated the package 32 of commands) for execution. The cloud-based package generator application 40 need only create and send the package 32 of commands as a file. The package 32 of commands may be downloaded to the local memory 74 of the programmable controller 20. Because multiple packages of commands may be stored in the programmable controller 20, a user may thus have a collection 302 of packages stored in the memory 74. The user enable and/or disable any particular package 32 of commands. Individual packages of commands, in other words, may be manually or automatically enabled or disabled. Each package 32 of commands may simply be a file of logic and actions to take, executed based on the date and time 76 associated with active/enabled commands 34 or events 304. The package 32 of commands may thus interface with a scheduler 306 (such as an electronic calendar) that compares the current date and time 78 to the dates and times 76 associated with each command 34 or logic statement.

Below is an exemplary package logic of the package 32 of commands, using a standard format (such as the application programming interfaces 42).

Execute Every 15 minutes −>
If OutsideTemperatureProbe01.value is > 80F AND
Window01.open.value != 0%
{

activate.device.WindowCloser01 until Window01.open.value = 0%

}
Elseif OutsideTemperatureProbe01.value < 75F AND
Window01.open.value < 50%
{

Activate.device.WindowCloser01 until Window01.open.value = 50%

}
Elseif OutsideTemperatureProbe01.value <65F AND
Window01.open.value >10%
{

Activate.device.WindowCloser01 until Window01.open.value = 10%

}

Here a window is opened or closed according to outside temperature. Logic may also be remotely created, and locally executed, to control a sprinkler system based on a soil moisture probe and/or the time of day. Chlorine may be injected into a pool based on a pool sensor and scheduler logic. A text message may be sent when a motion sensor senses motion during the day, and the programmable controller 20 may call police during nighttime hours. If a cell phone is not detected in the home, the programmable controller 20 may infer the house is not occupied, so the police may be immediately summoned when motion is sensed. Moreover, when the cell phone is not detected, and a door is open, calls or texts may be sent as alerts. The programmable controller 20 may activate cameras to capture images or video data. Messages may even be sent to an address or domain (such as www.onstar.com) associated with an automobile to alert a driver of some condition detected by the programmable controller 20. When the message is received, a controller in the automobile may cause the message to be displayed on a radio display, infotainment display, or heads-up display.

Logical packages of commands may thus be written using any software program. The package generation application 40, for example, may be a custom software package with lots of features for commanding the programmable controller 20. The package generation application 40, however, may simply be MICROSOFT® WORD® or incorporate a simple text editor that is used to create the package 32 of commands. Indeed, the programmable controller 20 itself may store and execute some text editor application 308, thus allowing a user to locally create and/or edit any package 32 of commands. The package 32 of commands may even be uploaded using an external memory interface, such as a USB drive. Regardless, once the package 32 of commands is loaded to the memory 74, the programmable controller 20 may operate in isolation to execute the package 32 of commands. No communication with the package generation application 40 is needed for execution.

As FIG. 23 illustrates, the programmable controller 20 may execute one or more events 304. The event 304 may be defined as a task for execution at the associated date and time 76. The event 304 may have some trigger, such as a sensor output (e.g., temperature, motion, or parameter value). The trigger, however, may also be based on detection, such as device presence on a network (e.g., WIFI® or BLUETOOTH®). The following logic statement, for example, may execute an event 304 based on motion in a kitchen:
event.sensor.motiondetector.Kitchen.activated.
   Events may be defined when a smartphone is not present or detected (e.g., event.wifidevice.MyPhone.notfound) or when medication is taken or opened (e.g., event.pillbox.Medication01.opened).

Events may also be stored. The programmable controller 20 may receive notification of some event 304, based on some sensor. For example, if daily medication is important, a pill bottle may have a sensor that activates when a lid or top is opened. The sensor sends an event to the programmable controller 20 when the lid is opened. The programmable controller 20 receives, stores, and timestamps the event with the date and time 76:

Package LarryMeds 01
onevent.PillOpenSensor01.triggered−>Set varLarryTookMeds01 = True
At 8:30 AM every day −>
If varLarryTookMeds01
{

varLarryTookMeds01 = False

}
Else
{

sendtext.LarrysPhone.message=”You forgot to take your 8 am meds

. . . please take them.”
}
At 9:00 AM every day −>
If varLarryTookMeds01
{

varLarryTookMeds01 = False

}
Else
{

sendtext.LarrysWifePhone.message=”Larry forgot to take his 8 am

meds . . . please remind him. He's not listening.”
}

Here, a daily event is set for 8 AM. If an event notification is not received by 8:30 AM (indicating the pill bottle has been opened), then programmable controller 20 causes a text message to be sent to “LarrysPhone” (“You forgot to take your 8 am meds . . . please taken them”). If the medication is still not taken by 9 AM, then a text message is sent to “LarrysWifePhone” as a further reminder. So, when events are not detected according to time, exemplary embodiments may take predetermined actions.

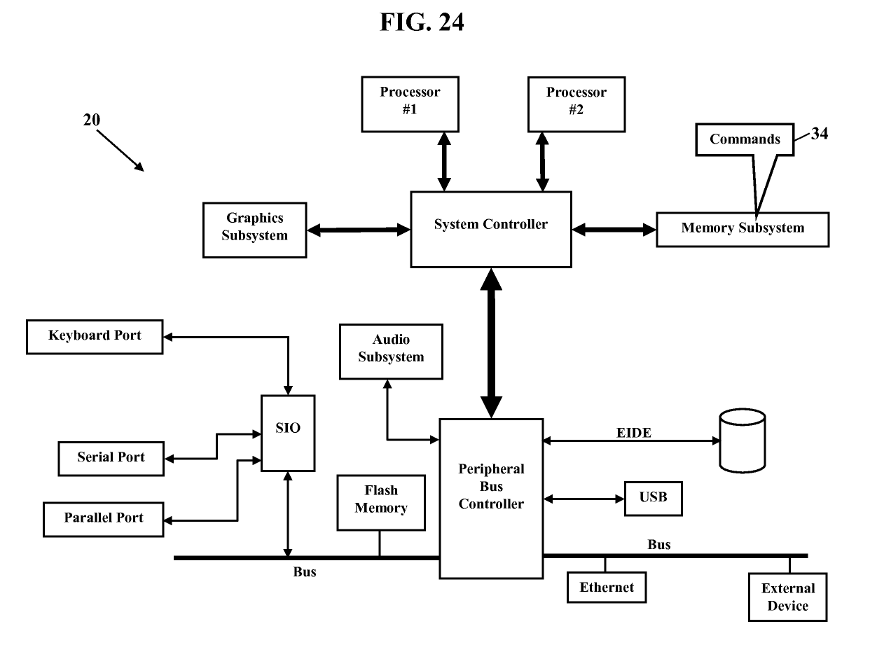

FIG. 24 is a schematic illustrating still more exemplary embodiments. FIG. 24 is a more detailed block diagram illustrating the programmable controller 20. The programmable controller 20 has one or more processors and storage devices. The programmable controller 20 executes the commands 34 to automate home and industrial equipment. The storage devices may include volatile, temporary RAM storage and non-volatile, programming read-only memory (“PROM”) that contains permanent aspects of operating instructions. The programmable controller 20 may include an internal bus provided by a backplane for operatively connecting input/output modules. The programmable controller 20 may receive the inputs and/or the commands (illustrated, respectively, as reference numerals 24 and 34 in the FIGS.) and, based thereon, sends the outputs as control signals to the output devices (illustrated, respectively, as reference numerals 36 and 22 in the FIGS.). Because the general aspects of the programmable controller 20 are well-known to those of ordinary skill in the art, no further detailed explanation is needed.

Exemplary embodiments may also include billing schemes. For example, a vendor of the package generation application may charge a fee for generating each command and/or each package of commands (illustrated, respectively, as reference numerals 40, 34, and 32 in the FIGS.). The vendor may additionally or alternatively charge a fee for each input 24 received. The vendor may maintain some billing database that tallies or sums the fees incurred by the programmable controller 20, perhaps on some monthly or other periodic basis. A payment account (such as a credit card number) may be associated with the programmable controller 20, and a financial transaction is initiated for payment of incurred charges.

Exemplary embodiments may be physically embodied on or in a computer-readable storage medium. This computer-readable medium may include CD-ROM, DVD, tape, cassette, floppy disk, memory card, USB, and large-capacity disks. This computer-readable medium, or media, could be distributed to end-subscribers, licensees, and assignees. A computer program product comprises processor-executable instructions for controlling devices, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method, comprising:
storing in a database a list of package generation applications for automated control of output devices;
associating controller identifiers in the database to network identifiers of the package generation applications for controlling programmable controllers;
receiving a query specifying one of the controller identifiers; and
retrieving one of the network identifiers from the database of package generation applications that is associated with the one controller identifier.

2. The method according to claim 1, further comprising sending a menu of package generation applications for controlling the one programmable controller.

3. The method according to claim 1, further comprising receiving a request for the menu of package generation applications.

4. The method according to claim 1, further comprising retrieving at least one web page describing the menu of package generation applications.

5. The method according to claim 1, further comprising displaying the menu of package generation applications.

6. The method according to claim 1, further comprising sending a routing message to send inputs to the one server address.

7. An apparatus, comprising:
a processor;
memory; and
code stored in the memory that when executed causes the processor to perform operations, the operations comprising:
receive a package of commands at a programmable controller for automation of an output device;
receive a date and time for execution of one of the commands;
compare the date and time for execution to a current date and time; and
execute the one command when the date and time for execution matches the current date and time,
wherein the command causes the programmable controller to control operation of the output device.

8. The apparatus according to claim 7, wherein the code further causes the processor to queue the one command for future execution when the date and time for execution fails to match the current date and time.

9. The apparatus according to claim 7, wherein the code further causes the processor to generate an output of the programmable controller that controls the output device.

10. The apparatus according to claim 9, wherein the code further causes the processor to evaluate the output to determine a performance of the package generation application.

11. The apparatus according to claim 10, wherein the code further causes the processor to store an evaluation result in a database.

12. The apparatus according to claim 11, wherein the code further causes the processor to compare the evaluation result to a performance threshold.

13. The apparatus according to claim 7, wherein the code further causes the processor to execute a text editor to create the package of commands.

14. The apparatus according to claim 7, wherein the code further causes the processor to:
evaluate the one command to determine a performance of the package generation application;
store an evaluation result in a database; and
compare the evaluation result to a performance threshold.

15. A computer readable medium storing processor executable instructions for performing a method, the method comprising:
receiving an input at a device generated by an input device for automation of an output device;
executing a package generation application by the device;
generating a package of commands by the package generation application from the input; and
sending the package of commands over a communications network to a programmable controller for automation of the output device.

16. The computer readable medium according to claim 15, further comprising instructions for sending a date and time to the programmable controller for execution of a command in the package of commands.

17. The computer readable medium according to claim 15, further comprising instructions for associating a controller identifier of the programmable controller to the device executing the package generation application.

18. The computer readable medium according to claim 15, further comprising instructions for associating a controller identifier of the programmable controller to a network identifier of the server executing the control program.

19. The computer readable medium according to claim 15, further comprising instructions for sending a query for a network identifier associated with the programmable controller.

20. The computer readable medium according to claim 15, further comprising instructions for receiving a routing message that identifies an address associated with the programmable controller.
